(19) United States
(12) Patent Application Publication
(10) Pub. No.: US 2016/0275823 A1
(43) Pub. Date: Sep. 22, 2016

(54) ROLL-SHAPED-COMPOSITE-LINERLESS LABEL

(71) Applicant: SATO HOLDINGS KABUSHIKI KAISHA, Tokyo (JP)

(72) Inventor: Satoru HONDA, Tokyo (JP)

(21) Appl. No.: 15/024,736

(22) PCT Filed: Sep. 19, 2014
(86) PCT No.: PCT/JP2014/074871

§ 371 Date: Mar. 24, 2016

(30) Foreign Application Priority Data
Sep. 26, 2013 (JP) 2013-199413

(51) Int. Cl. G09F 3/02; G09F 3/10

(52) U.S. Cl. CPC G09F 3/02; G09F 3/10; G09F 2003/0211; G09F 2003/023; G09F 2003/0229

(57) ABSTRACT

A roll-shaped-composite-linerless label. The roll-shaped-composite-linerless label features good peel property of a linerless label and a thermal transfer ribbon during printing, avoids lacking a part of transferred characters, and further features adhesion to an adherend stronger than conventional labels. A roll-shaped-composite-linerless label includes a long-shaped thermal transfer ribbon and a long-shaped linerless label. The thermal transfer ribbon includes an ink layer on one surface of a film. A back coat agent is applied on another surface. The linerless label includes an adhesive agent layer on one surface of a base material. The linerless label has a print surface on another surface. Ink of the ink layer is transferred to the print surface. The back coat agent contains silicone-based rubber or a mixture of silicone rubber and silicone oil as a main component. The adhesive agent layer is formed by an emulsion-based adhesion. The surface of the thermal transfer ribbon on which the back coat agent has been applied and the adhesive agent layer of the linerless label are stacked and wound into a roll shape.

### TECHNICAL FIELD

The present invention relates to a roll-shaped-composite-linerless label formed by stacking a linerless label on a thermal transfer ribbon loaded to a printer.

### BACKGROUND ART

Conventionally, as an adhesive applied over a reverse surface of a linerless label, a hot melt type adhesive achieving stickiness by heating, and a pressure-sensitive adhesive exhibiting stickiness even at ordinary temperatures, are available. The use of the hot melt type adhesive requires a heating device. On the other hand, in the case of using the pressure-sensitive adhesive, a release agent such as silicone is applied over the surface of the label. This restrains the stickiness of the label wound into a roll shape, thus providing good peel property.

However, in the case of pressure-sensitive adhesive, a step of a silicone process on the surface of the label is required. In the case of pressure-sensitive adhesive, performing this silicone process repels ink of the thermal transfer ribbon by the release agent during printing. This fails to transfer the ink. Alternatively, even if the printed characters are transferred, the printed barcodes and characters may be easily peeled off or faint and patchy due to a careless contact.

Therefore, the applicant of this application has proposed the roll-shaped-composite-linerless label formed by stacking the linerless label and the thermal transfer ribbon and formed into a roll shape (Patent Literature 1). This Patent Literature 1 uses re-peelable, re-adhesible adhesive microspheres as the adhesive. This improves the peel property of the linerless label and the thermal transfer ribbon during printing, thus forming the roll-shaped-composite-linerless label where a part of the transferred characters does not lack.

This roll-shaped-composite-linerless label formed by stacking the linerless label and the thermal transfer ribbon and formed into the roll shape eliminates the need for liner, and separately preparing the thermal transfer ribbon is unnecessary, considerably ideal for manufacturing labels.
Patent Literature 1: Japanese Patent No. 3529120

However, since the roll-shaped-composite-linerless label in Patent Literature 1 uses the re-peelable, re-adhesible adhesive microspheres as the adhesive, the roll-shaped-composite-linerless label is configured to be peeled off again and adhere again. On the contrary, the roll-shaped-composite-linerless label lacks in adhesion to an adherend. This causes a problem that an application usable as a label is limited.

With the conventional technique, replacing the adhesive microspheres in Patent Literature 1 with an adhesive with strong adhesion deteriorates the peel property of the label and inkribbon in a printing step, possibly resulting in poor printing.

The problem of the present invention is to provide a roll-shaped-composite-linerless label. The roll-shaped-composite-linerless label features good peel property of the linerless label and the thermal transfer ribbon during printing, avoids lacking a part of transferred characters, and further features adhesion to the adherend stronger than the conventional labels.

### SUMMARY OF INVENTION

The present invention solves the problem by solutions described below.

The invention of claim 1 is a roll-shaped-composite-linerless label that includes a long-shaped thermal transfer ribbon and a long-shaped linerless label. The thermal transfer ribbon includes a heat-transferable ink layer on one surface of a film. A back coat agent is applied on another surface. The linerless label includes an adhesive agent layer on one surface of a base material. The linerless label has a print surface on another surface. Ink of the ink layer is transferred to the print surface. The back coat agent contains silicone-based rubber or a mixture of silicone rubber and silicone oil as a main component. The adhesive agent layer is formed by an emulsion-based adhesion. The surface of the thermal transfer ribbon on which the back coat agent has been applied and the adhesive agent layer of the linerless label are stacked and wound into a roll shape.

The invention of claim 2 is the roll-shaped-composite-linerless label according to claim 1 configured as follows. The roll-shaped-composite-linerless label includes a glueless portion. The glueless portion is disposed in a range of 0.5 mm to 3 mm from an end portion on both end portions in a lateral direction of the linerless label. The adhesive agent layer is not formed on the glueless portion.

The invention of claim 3 is the roll-shaped-composite-linerless label according to claim 1 or claim 2 configured as follows. The back coat agent is applied over the other surface of the film to become a coated film at a thickness of 0.001 μm to 0.5 μm.

The invention of claim 4 is the roll-shaped-composite-linerless label according to any one of claim 1 to claim 3 configured as follows. The adhesive agent layer has a 180-degree peel adhesion with respect to a stainless steel test plate specified in JIS Z1538 and Z0237 of 5880 mN (milli newton)/25 mm width or more.

The invention of claim 5 is the roll-shaped-composite-linerless label according to any one of claim 1 to claim 4 configured as follows. The roll-shaped-composite-linerless label includes a temporarily adhered portion. The temporarily adhered portion is formed by stacking the surface to which the back coat agent is applied and the adhesive agent layer. The temporarily adhered portion has a peel force of 49 mN/50 mm width to 686 mN/50 mm width or less when a 180-degree peel test is conducted at a pulling rate of 300 mm/min. In the 180-degree peel test, the roll-shaped-composite-linerless label is designed to have a width of 50 mm while the thermal transfer ribbon is secured.

The invention of claim 6 is the roll-shaped-composite-linerless label according to claim 5 configured as follows. The peel force of the temporarily adhered portion is from 49 mN/50 mm width to 490 mN/50 mm width or less.

According to the present invention, the following roll-shaped-composite-linerless label can be provided. The roll-shaped-composite-linerless label features good peel property of the linerless label and the thermal transfer ribbon during printing, avoids lacking a part of transferred characters, and further features adhesion to the adherend stronger than the conventional labels.

### BRIEF DESCRIPTION OF DRAWINGS

FIG. 1 is a perspective view of a roll-shaped-composite-linerless label according to the present invention.

FIG. 2 is a cross-sectional view taken along the line II-II in FIG. 1.

FIG. 3 is a perspective view of a roll-shaped-composite-linerless label according to another aspect of the present invention.

FIG. 4 is a cross-sectional view taken along the line III-III in FIG. 3.

FIG. 5 is a drawing describing a peeling test.

FIG. 6 is a schematic side view of a printer 20 that loads a roll-shaped-composite-linerless label 8 according to the embodiment and performs printing on a linerless label 3 using a thermal transfer ribbon 5.

FIG. 7 is a table showing results of an environmental resistance test and a printing test preparing a plurality of samples whose peel forces of a temporarily adhered portion of the roll-shaped-composite-linerless label of the present invention differ.

### DESCRIPTION OF EMBODIMENTS

The following describes preferred aspects to embody the present invention with reference to the drawings or similar references.

### Embodiment

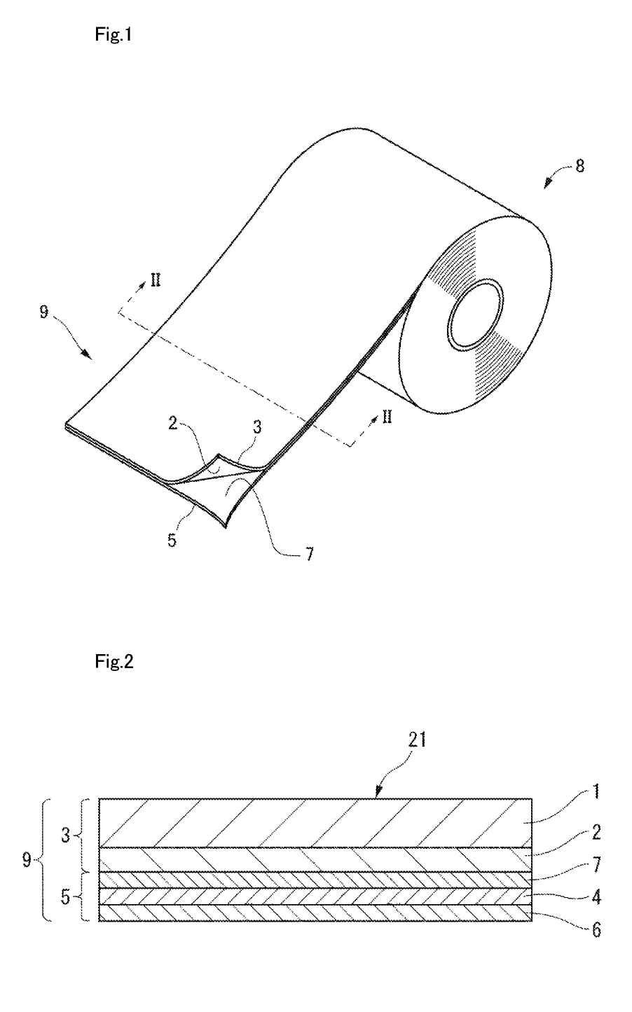

FIG. 1 is a perspective view of a roll-shaped-composite-linerless label according to the present invention. FIG. 2 is a cross-sectional view taken along the line II-II in FIG. 1. It should be noted that, including FIG. 1 and FIG. 2, respective drawing described below are schematic views. For ease of understanding, sizes and shapes of the respective portions are exaggeratedly illustrated as necessary. The following describes with specific values, shapes, materials, or similar specifications; however, these specifications can be appropriately changed.

A roll-shaped-composite-linerless label 8 in this embodiment is wounded into a roll shape with a linerless label 3 temporarily adhered to a thermal transfer ribbon 5. The roll-shaped-composite-linerless label 8 is formed into a long shape where a base material 1, an adhesive agent layer 2, a back coat agent 7, a film 4, and an ink layer 6 are laminated in this order from upward in FIG. 2. The base material 1 and the adhesive agent layer 2 constitute the linerless label 3. The film 4, the ink layer 6, and the back coat agent 7 constitute the thermal transfer ribbon 5. The roll-shaped-composite-linerless label 8 is wound into the roll shape such that the base material 1 side is on the outer periphery side. It should be noted that, in FIG. 1, the extracted portion of the roll-shaped-composite-linerless label 8 is referred to as a composite linerless label 9.

The base material 1 is formed by a paper base material such as high-quality paper, coated paper, and art paper. The adhesive agent layer 2 is formed on one surface of the base material 1. A print surface 21 is formed on the other surface. It should be noted that the print surface 21 of the base material 1 is constituted such that a heat transfer property of the ink layer 6 described later is satisfactory.

The adhesive agent layer 2 is formed by an emulsion-based adhesion. The emulsion-based adhesion is water-soluble adhesion that can be diluted with water. The emulsion-based adhesion easily penetrates the base material 1 using the paper base material. Additionally, the label formed of paper base is easily treated with a generally-used adhesion. This adhesive agent layer 2 features a 180-degree peel adhesion with respect to a stainless steel test plate specified in JIS Z1538 and Z0237 of 5880 mN/25 mm width or more, having a so-called strong stickiness.

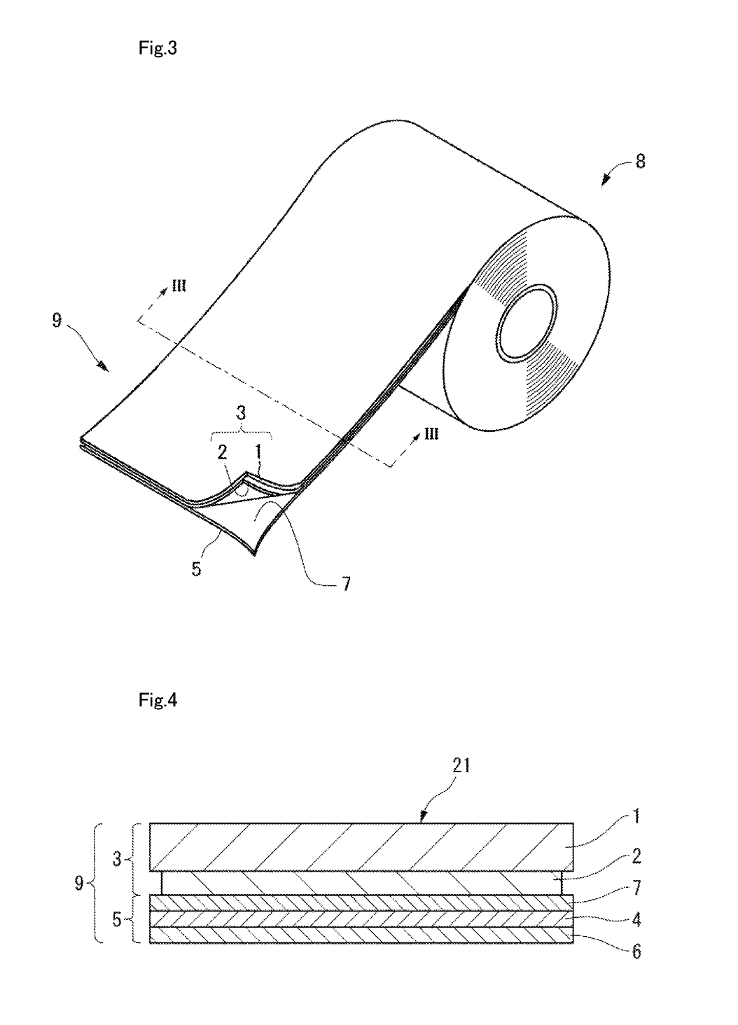

Assume the case where the adhesion of the adhesive agent layer 2 of the linerless label 3 has strong stickiness like 5880 mN/25 mm width or more. Rolling up the linerless label 3 into the roll shape with the linerless label 3 stacked on the thermal transfer ribbon 5 cause to exudation of adhesion from a slit surface. Therefore it is occur that the thermal transfer ribbon 5 is cut or that the paper materials are peeled off from the base material 1 (so called paper peeling) when the thermal transfer ribbon 5 is peeled off from the composite linerless label 9. In this case, on both sides (an end portion in the line III-III direction illustrated in FIG. 3 and FIG. 4) of the roll-shaped-composite-linerless label 8 according to another aspect of the present invention illustrated in FIG. 3, a glueless portion over which the adhesion is not applied (an adhesive agent layer is not disposed) is disposed by 0.5 mm to 3 mm, more preferably from 1 mm to 2 mm. This prevents exudation of the adhesion from the slit surface, ensuring preventing the cut ribbon and paper peeling of the base material. The glueless portion smaller than 0.5 mm fails to prevent the exudation of the glue from the slit surface. The glueless portion larger than 3 mm floats the peripheral edge portions when the linerless label 3 is pasted to the adherend as a label piece 19 after printing as described later. This makes it difficult to maintain good adhesion with the adherend.

The film 4 is a long-shaped film formed by synthetic resin such as polyester and is a member serving as a base for the thermal transfer ribbon 5.

The ink layer 6 is disposed on one surface of the film 4. The ink layer 6 is formed by ink to be thermal-transferred by a thermal head 15 described later to the print surface 21.

The back coat agent 7 is applied and formed over the other surface of the film 4. The back coat agent 7 is in contact with and stacked on the adhesive agent layer 2. The contact of the adhesive agent layer 2 to this back coat agent 7 causes the linerless label 3 to temporarily adhere to the thermal transfer ribbon 5, thus integrating the linerless label 3 and the thermal transfer ribbon 5. The main component of the back coat agent 7 is silicone-based rubber or a mixture of silicone rubber and silicone oil. The back coat agent 7 is applied over the other surface of the film 4. The application is preferably performed such that the coated film has a thickness of 0.001 μm to 0.5 μm. The coated film thickness thinner than 0.001 μm deteriorates non-stickiness (peel property) and slipperiness as a back coat layer. This makes peeling off the linerless label 3 difficult and also causes noise and poor printing when the linerless label 3 is in contact with and is conveyed with the thermal head 15, which will be described later. The coated film thickness thicker than 0.5 μm stabilizes the peeling off the linerless label 3; however, since the thickness of the ribbon is too thick, this involves a cost increase during production. With the components and coated film thickness, the back coat agent 7 features good slipperiness with the thermal head 15, which will be described later, and good peel property with the adhesive agent layer 2.

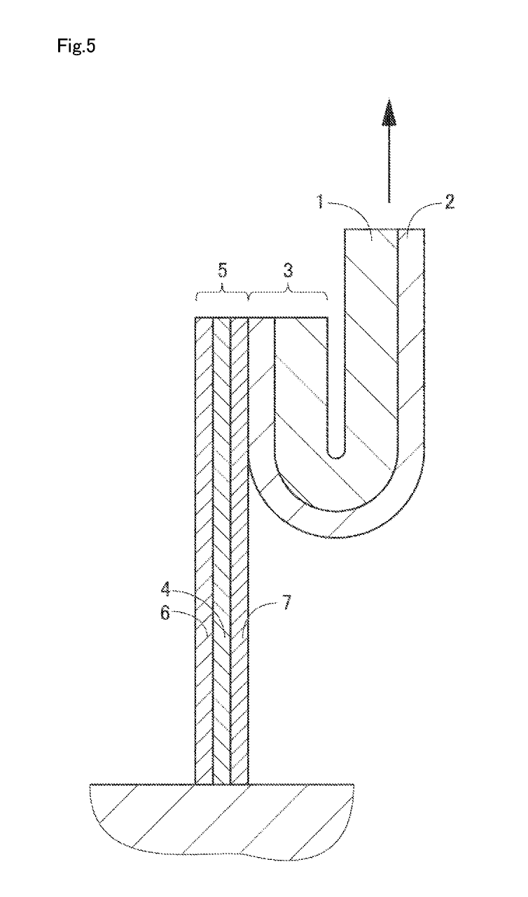

The temporarily adhered portion where the surface on which the back coat agent 7 is applied and the adhesive agent layer 2 are stacked is constituted such that the peel force by a predetermined peeling test becomes a predetermined value or less. Here, this peeling test will be described. FIG. 5 is a drawing describing the peeling test. The roll-shaped-composite-linerless labels 8 as a test object, which are used for this peeling test, with a width of 50 mm are prepared. In the temporarily adhered portion, the linerless label 3 is peeled away from the thermal transfer ribbon 5. The one end of the thermal transfer ribbon 5 is fixed. One end portion of the peeled linerless labei 3 is strained to perform the 180 peeling test under the conditions of a tensile rate of 300 mm/min. Then, the peel force is measured by a load cell or a similar measuring apparatus. It is preferable that the peel force peeling the temporarily adhered portion of the linerless label 3 and the thermal transfer ribbon 5 be from 49 mN/50 mm width to 686 mN/50 mm width or less in the above-described peeling test. More preferably, the peel force of the temporarily adhered portion is from 49 mN/50 mm width to 490 mN/50 mm width or less. The smaller peel force of the temporarily adhered portion is desirable for operations during printing. The peel force within the above-described range ensures easy peeling by a printer, which will be described later, not providing negative effects to the printing.

The adhesive agent layer 2 of the roll-shaped-composite-linerless label 8 has strong stickiness as described above. However, the use of the above-described back coat agent 7 for the thermal transfer ribbon 5 configures an aspect that allows the roll-shaped-composite-linerless label 8 to peel off the temporarily adhered portion with the above-described small peel force.

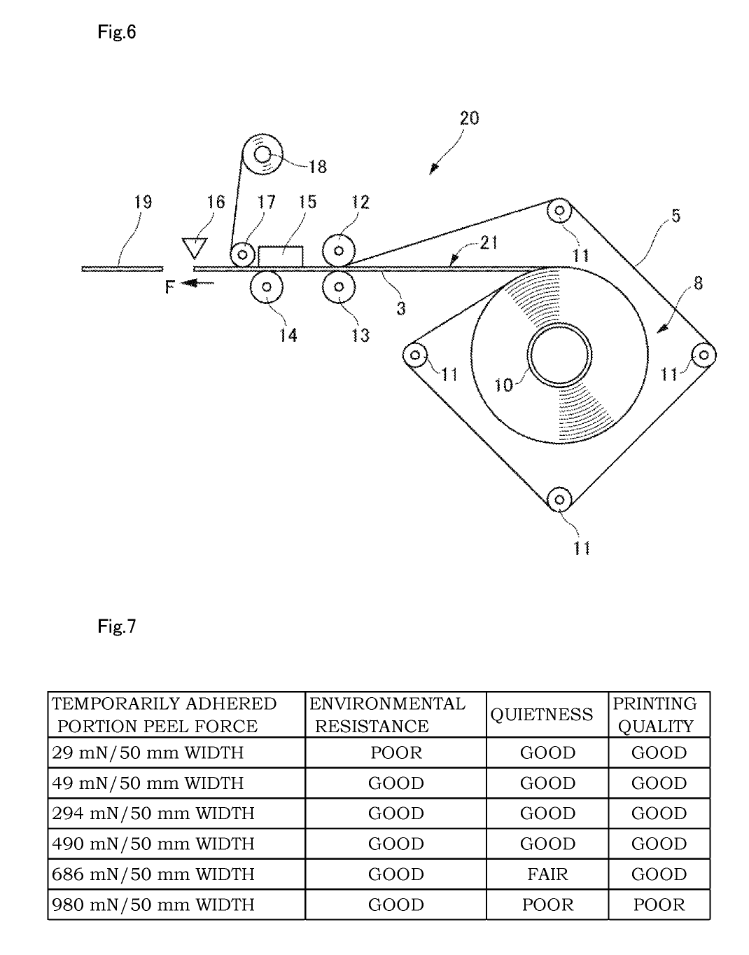

FIG. 6 is a schematic side view of the printer 20 that loads the roll-shaped-composite-linerless label 8 according to the embodiment and performs printing on the linerless label 3 using the thermal transfer ribbon 5. It should be noted that, when the following description describes a direction, such as upper and lower, this means the direction in FIG. 6. The printer 20 comprises a holding shaft 10, guide rollers 11, press-bonding rollers 12 and 13, a platen roller 14, the thermal head 15, a dicing mechanism 16, a turning roller 17, and a rolling-up shaft 18.

The holding shaft 10 is a shaft to which the roll-shaped-composite-linerless label 8 is loaded. In the composite linerless label 9 extracted from the roll-shaped-composite-linerless label 8 loaded to the holding shaft 10, the linerless label 3 is properly peeled away from the thermal transfer ribbon 5 significantly, the linerless label 3 is transported in the horizontal direction, and the thermal transfer ribbon 5 is transported downward. It should be noted that, at the site from which the linerless label 3 is peeled away from the thermal transfer ribbon 5, a peeling member such as a peeling plate or the turning roller may be disposed.

The guide roller 11 is a roller that guides the thermal transfer ribbon 5 which has been peeled and has been transported downward. The plurality of guide rollers 11 are disposed at the peripheral area of the holding shaft 10. The thermal transfer ribbon 5 that has been transported downward is guided by the respective guide rollers 11 and is transported counterclockwise, thus transported in a direction identical to the linerless label 3.

The respective press-bonding rollers 12 and 13 are disposed opposed to one another. The press-bonding rollers 12 and 13 are rollers that press-bond the ink layer 6 of the thermal transfer ribbon 5 to the print surface 21 of the linerless label 3. The thermal transfer ribbon 5 that has peeled from the linerless label 3 is guided by the respective guide rollers 11, and then the ink layer 6 of the thermal transfer ribbon 5 faces a direction in contact with the print surface 21 of the linerless label 3. The thermal transfer ribbon 5 is conveyed between the press-bonding roller 12 and the press-bonding roller 13, thus press-bonding the ink layer 6 to the print surface 21.

The platen roller 14 is coupled to a feed motor (not illustrated) via a timing belt (not illustrated). The platen roller 14 is rotatably driven by driving of the feed motor.

The thermal head 15 includes a large number of plural heating elements in the width direction and is disposed opposed to the platen roller 14. These heating elements are put to the thermal transfer ribbon 5 with nipping the linerless label and the thermal transfer ribbon 5 between the thermal head 15 and the platen roller 14. The thermal head 15 is pressurized in the orientation of the platen roller 14. The thermal head 15 selectively heats the heating elements to cause the ink to transfer from the thermal transfer ribbon 5 to the print surface 21 to print barcodes, characters, or similar data.

The dicing mechanism 16 dices the printed linerless label 3 further transported in the F direction, which is a transport direction, at predetermined intervals to form the label pieces 19. The specific structure of the dicing mechanism 16 may be any structure. The diced label pieces 19 are pasted to a product or similar goods with the adhesive agent layer 2.

The turning roller 17 turns the conveying direction of the thermal transfer ribbon 5 after the use of transfer by the thermal head 15 to separate the thermal transfer ribbon 5 from the linerless label 3 again. The rolling-up shaft 18 rolls up the thermal transfer ribbon 5 turned by the turning roller 17.

It should be noted that, on the platen roller 14, the press-bonding roller 13, and a transport path of the linerless label 3, which is transported inside the printer 20, non-adhesive coating or a similar process is performed with silicone or a similar material. Therefore, even if the linerless label 3 is transported with this adhesive agent layer 2 exposed, this ensures smooth conveyance.

FIG. 7 shows results of conducting a test on an environment resistance under a storage environment, and a peeling sound when the linerless label 3 is peeled away from the thermal transfer ribbon 5, and a printing quality using the printer 20, which is illustrated in FIG. 6. The test was conducted preparing a plurality of roll-shaped-composite-linerless labels with different peel forces, when the linerless label 3 is properly peeled away from the thermal transfer ribbon 5.

According to the results of this test, in the case of the peel force when the linerless label 3 is properly peeled away from the thermal transfer ribbon 5 being 29 mN/50 mm width, the peeling sound and the printing quality during printing by the printer 20 were good. However, since the peel force of the temporarily adhered portion is weak, due to expansion and contraction of the linerless label 3 or a similar error caused by humidity or a similar cause, the linerless label 3 is peeled away from the thermal transfer ribbon 5, resulting in creases of ruck and peeling between the layers. Therefore, it has found that the peel force is not suitable for storage. The peel force of the temporarily adhered portion being 686 mN/50 mm width or more requires stronger force that the linerless label 3 is peeled away from the thermal transfer ribbon 5. Accordingly, at the peel force, a noise (a peeling sound) occurred when the printer 20 peeled the linerless label 3 from the thermal transfer ribbon 5. Further, at the peel force of the temporarily adhered portion of 980 mN/50 mm width, the platen roller 14 fails to appropriately feed the composite linerless label or the linerless label 3 and the thermal transfer ribbon 5. This caused printing shrinkage, and excessive pulling force to the ribbon broken (run out of the ribbon).

The following has been found from the above-described test results. The peel force that the linerless label 3 is peeled away from the thermal transfer ribbon 5 is preferably within the range of 49 mN/50 mm width to 686 mN/50 mm width, more preferably in the range of 49 mN/50 mm width to 490 mN/50 mm width.

According to this embodiment, the adhesive agent layer 2 was an emulsion-based adhesion and had strong stickiness of the peel adhesion being 5880 mN/25 mm width or more. Additionally, the back coat agent 7 whose main component was silicone-based rubber or a mixture of silicone rubber and silicone oil was employed.

According to another aspect of the embodiment, the glueless portion of 0.5 mm to 3 mm over which an adhesion is not applied was disposed on both end portions in the lateral direction of the linerless label 3 of the roll-shaped-composite-linerless label 8.

This embodiment ensures achieving the roll-shaped-composite-linerless label 8 with good peel property of the linerless label 3 and the thermal transfer ribbon 5 while featuring stickiness stronger than the conventional labels by the combination of this adhesive agent layer 2 and the back coat agent 7. This is a special effect obtained by the combination of the above-described adhesive agent layer 2 and back coat agent 7. It should be noted that, the combination of emulsion-based adhesion with a copolymer of silicone and polymer, which has been conventionally used as a back coat agent, exhibits poor peel property, and therefore is of no practical use.

Since the roll-shaped-composite-linerless label 8 of this embodiment has the strong stickiness as described above, for example, the roll-shaped-composite-linerless label 8 is also can be used for an application where a label is desired not to be easily peeled off like a luggage tag label or a similar label.

The roll-shaped-composite-linerless label 8 of this embodiment features good peel property between the linerless label 3 and the thermal transfer ribbon 5 as described above. Accordingly, this prevents creases due to meandering, and prevents a lack of a part of printed characters, and ensuring smooth printing.

It should be noted that, this description and the claims describe an output of various pieces of information by the printer as “printing” as usual way of use by those skilled in the art. However, as described above, the description of “printing” means the output of information by the printer. Therefore, “printing” is not limited to the output of characters but has wide meaning including outputs of diagrams such as barcodes, images, or similar data.

### REFERENCE SIGNS LIST

1 base material
2 adhesive agent layer
3 linerless label
4 film
5 thermal transfer ribbon
6 ink layer
7 back coat agent
8 roll-shaped-composite-linerless label
9 composite linerless label
10 holding shaft
11 guide roller
12, 13 press-bonding roller
14 platen roller
15 thermal head
16 dicing mechanism
17 turning roller
18 rolling-up shaft
19 label piece
20 printer
21 print surface

1. A roll-shaped-composite-linerless label, comprising:
a long-shaped thermal transfer ribbon that includes a heat-transferable ink layer on one surface of a film, a back coat agent being applied on another surface; and
a long-shaped linerless label that includes an adhesive agent layer on one surface of a base material, the linerless label having a print surface on another surface, ink of the ink layer being transferred to the print surface, wherein:
the back coat agent contains silicone-based rubber or a mixture of silicone rubber and silicone oil as a main component,
the adhesive agent layer is formed by an emulsion-based adhesion, and
the surface of the thermal transfer ribbon on which the back coat agent has been applied and the adhesive agent layer of the linerless label are stacked and wound into a roll shape.

2. The roll-shaped-composite-linerless label according to claim 1, further comprising
a glueless portion disposed in a range of 0.5 mm to 3 mm from an end portion on both end portions in a lateral direction of the linerless label, the adhesive agent layer being not formed on the glueless portion.

3-5. (canceled)

6. The roll-shaped-composite-linerless label according to claim 5, wherein
the peel force of the temporarily adhered portion is from 49 mN/50 mm width to 490 mN/50 mm width or less.

7. The roll-shaped-composite-linerless label according to claim 1, wherein
the back coat agent is applied over the other surface of the film to become a coated film at a thickness of 0.001 μm to 0.5 μm.

8. The roll-shaped-composite-linerless label according to claim 1, wherein
the adhesive agent layer has a 180-degree peel adhesion with respect to a stainless steel test plate specified in JIS Z1538 and Z0237 of 5880 mN/25 mm width or more.

9. The roll-shaped-composite-linerless label according to claim 1, further comprising
a temporarily adhered portion formed by stacking the surface to which the back coat agent is applied and the adhesive agent layer, wherein
the temporarily adhered portion has a peel force of 49 mN/50 mm width to 686 mN/50 mm width or less when a 180-degree peel test is conducted at a pulling rate of 300 mm/min, the roll-shaped-composite-linerless label being designed to have a width of 50 mm while the thermal transfer ribbon is secured in the 180-degree peel test.
